(19) United States
(12) Patent Application Publication
(10) Pub. No.: US 2003/0069152 A1
(43) Pub. Date: Apr. 10, 2003

(54) Multipurpose, multifunctional complex cleaning and washing agent

(76) Inventor: Dai-Uk Kim, Seoul (KR)

Correspondence Address: Blakely Sokoloff Taylor & Zafman, 12400 Wilshire Blvd Seventh Floor, Los Angeles, CA, 90025-1026, US

(21) Appl. No.: 10/203,504

(22) PCT Filed: Jan. 29, 2001
(86) PCT No.: PCT/KR01/00116

(30) Foreign Application Priority Data
Feb. 9, 2000 (KR) 2000/5875

(51) Int. Cl. C11D 17/00

(52) U.S. Cl. 510/245; 510/421; 510/426; 510/506

(57) ABSTRACT

The present invention is good for complex cleaning and degreasing agent which can save energy, and can shorten the cleaning time and show good cleaning and degreasing proficiency without changing the systems being used, and impairing the raw materials. The present invention is also for cleaning and degreasing agent that maintains the best alkalinity and can be used according to each characteristics of process, without being restrained under the scope of available temperature. The present invention includes the surfactant and alkaline builder of the below formula 1: R—O—(CH₂CH₂O)m-H. formula 2, formula 3: R-Ph-O—(CH₂CH₂O)-m-H, and formula 4: R-Ph-SO₃⁻M⁺. Wherein, from 1 to formula 4 R is alkyl group of which carbon number is 3-19, Ph is phenyl group, m is 1.5-12 mol for formula 1 and 2, and 13-19 moles for formula 3, n is 2-15 mol, and M is counter ion.

### BACKGROUND OF THE INVENTION

(a) Field of the Invention

The present invention relates to a multipurpose, multifunctional complex cleaning and degreasing agent composition which does not impair shaped material such as metal, silicon, carbon, fiberglass, graphite, ceramic, plastic, vinyl, carpet, rug, natural or synthetic rubber, etc. The present invention can be used as a spray or in liquid form, and proves to possess great cleaning and degreasing performance while maintaining an anti-foaming property at room temperature during use.

(b) Description of the Related Art

Generally, metallic goods accompany the following processes. First, beef tallow or synthetic ethers rolling agent used while iron making and refining processes must be treated chemically. The process comprises removing fat with cleaning agent at high temperature, washing with deionized water at high temperature, drying, coiling. Second, metallic goods must be treated chemically before the coating process. The process generally comprises removing fat with cleaning agent at high temperature, washing with deionized water at high temperature, controlling of the metallic surface, chemical treating, washing with deionized water, drying and coating.

These cleaning agents have been introduced through various literatures. The ingredients of the cleaning and degreasing agent are generally classified into alkaline builders, surfactants or anti-foaming agents, and generally powder-type cleaning agents in which a mixture of these ingredients are dissolved and used.

This cleaning and degreasing agent is used for removing oil and pollutants on metallic surfaces by spray or deposit method. During the iron making and refining processes, the temperature of the solution is generally 85-90° C. and the cleaning time is 1-3 minutes, and during the manufacturing process, the temperature of the solution is 40-70° C., and the cleaning time is 1-10 minutes. However, as high alkaline cleaning agent is used during both processes, the use of the cleaning and degreasing agent is restricted according to the kind of metal or the sensitivity of metal to the surface reaction. To alleviate these problems, if we decrease alkalinity and at the same time decrease the temperature of the solution to room temperature, the cleaning performance decreases and the cleaning time lengthens, resulting in a problem such that remnants on the metallic surface after washing impairs the effect of the chemical treatment, which in turn affects the manufacturing process.

On the other hand, if the alkalinity of the solution decreases and the temperature of the solution decrease, the foaming phenomenon elevates and as these bubbles penetrate into the interior of goods, cleaning performance decreases. Therefore, oil and pollutants are poorly removed from the interior of goods.

However, it should be noted that the surfactant undergoes a chemical reaction at high temperature, and loses the faculty of the surfactant and decreases the faculty of oil removal. Further, the mechanical or physical complement is not easy because of restriction of coverage of available temperature at each process.

On the other hand, the complex cleaning and degreasing agent is a surface adhesion abrasion type generally used at room temperature.

If we select low alkalinity and low cloud point surfactant not to impair the coated surface or characteristic condition of the raw material, the cleansing performance becomes weak. Therefore, the removal of oil or pollutants is poor, despite all various times of rubbing and polishing.

There are increased interests in relation to complex cleaning and degreasing agents, which save energy and prove to have good cleaning and degreasing proficiency, without changing the systems being used and impairing the raw materials, and which can maintain the best alkalinity without being restricted under available temperature range and which can be used according to each characteristics of process between room temperature and less than 100° C.

### SUMMARY OF THE INVENTION

Therefore, it is an object of the present invention to provide a multipurpose, multifunctional complex cleaning and degreasing washing agent that does not impair raw materials.

It is another object of the present invention to provide a multipurpose, multifunctional complex cleaning and degreasing agent that shows good cleaning proficiency over a wide temperature range for various goods.

In order to achieve these objects, the present invention provides a complex cleaning and degreasing agent comprising an alkaline builder and surfactants of the following Formulae 1 to 4.

[Formula 1]

R—O—(CH₂CH₂O)m-H

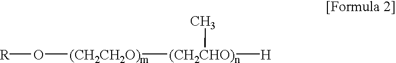

[Formula 3]

R-Ph-O—(CH₂CH₂O)m-H

[Formula 4]

R-Ph-SO₃⁻M⁺

Wherein, R is C3-C19 alkyl group, Ph is phenyl group, m is 1.5-12 for Formula 1 and Formula 2, and 13-19 for Formula 3, n is 2-15, and M is counter ion.

Preferably, the mole ratio of m/n of the Formula 3 is 0.5-1.27, and the contents of the complex surfactants are 0.1-10.0 g per 1 liter of cleaning agent. The present invention may further comprise glycol ether, enzyme, and chelating agent.

### DETAILED DESCRIPTION OF THE INVENTION

Herein below is a detailed description of the present invention.

The cleaning composition of the present invention is characterized by comprising glycol ethers, enzyme, chelating agent, alkaline builder and complex surfactants that can be expressed as the following general formulae.

The cleaning and degreasing agent is characterized in that it can be used from room temperature to less than 100° C., and it is biodegradable, non ozone-depletive, and non-toxic.

The composition of the present invention solves the above-mentioned problems by 1) containing 0.1-10.0 g of complex surfactants per 1 liter of the composition; 2) controlling mole ratio of m/n of each complex surfactant; 3) controlling added mole numbers of m and n of each complex surfactant; and 4) defining R of each complex surfactant.

The complex surfactant that is an indispensable ingredient of the complex cleaning and degreasing agent of the present invention consists of three kinds of non-ionic surfactants and one kind of anionic surfactant having the general formulae as follows.

[Formula 1]

R—O—(CH₂CH₂O)m-H

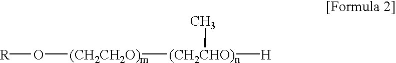

[Formula 3]

R-Ph-O—(CH₂CH₂O)-m-H

[Formula 4]

R-Ph-SO₃⁻M⁺

Wherein, R is alkyl group, Ph is phenyl group, and M is a counter ion. The number of carbon of the alkyl group R is 3-19, and each R may be one alkyl group or a combination of alkyl group. R may be synthetic, abstracted or derivatives therefrom.

R is generally made of saturated hydrocarbon, so one that does not have unsaturated bond is generally used, but one that has unsaturated bond such as olein acid possesses no problems.

When a cleaning and degreasing agent composition consists of an alkaline builder and a single surfactant without comprising glycol ethers, enzyme, chealating agent, If the number of carbon of R is less than 8, the composition has poor cleaning proficiency and even worse cleaning proficiency at room temperature, thus it cannot be used as a room temperature cleaning agent. In addition, if the number of carbon of R is over 18, not only does the cleaning proficiency of the composition decrease, but also there is a shortcoming of no easily being washed at washing after cleaning.

However, when a complex cleaning and degreasing agent composition comprises glycol ethers, enzyme, chelating agent, alkaline builders and complex surfactants, if the number of carbon of each R is less than 3, the composition has poor cleaning proficiency within available temperature range. And, if the number of carbon each R is over 19, there is no industrial availability, because the quantity of glycol ethers, enzyme, chealating agent and complex surfactant is too many.

The m, which is the number of moles of ethylene oxide, is 1-15 for Formula 1 and Formula 2, and preferably 1.5-2. The m is 10-25 for Formula 3, and preferably 13-19. The n, which is the number of moles of propylene oxide, is preferably 2-15.

The most preferable added moles of m and n are variable according to the kind of R. However, when a cleaning and degreasing agent composition consists of an alkaline builder and a single surfactant without glycol ethers, enzyme and chealating agent, if m is less than 4, the composition has weak hydrophilicity, poor solubility and cleaning proficiency, although good in anti-foaming property. If m is over 12 moles, bubbling occurs at room temperature, so we cannot overcome the problem.

However, when a complex cleaning and degreasing agent composition comprises glycol ethers, enzyme, chealating agent, alkaline builders and complex surfactants, if m is less than 1.5, the composition has weak hydrophilicity, and poor solubility and cleaning property although good anti-foam-removing property within available temperature. If the m of each complex surfactant is over 19, bubbling occurs at room temperature, and we cannot solve the problem.

With regard to the n, when a cleaning and degreasing agent composition is made up of an alkaline builder and a single surfactant without glycol ethers, enzyme and chealating agent, if n is less than 2, the composition has too much bubbling. If n is over 15, cleaning proficiency decreases, because changes occur with the lapse of time at high temperature.

However, when a complex cleaning and degreasing agent composition comprises glycol ethers, enzyme, chealating agent, alkaline builders and complex surfactant, even if n is 2, the composition has no bubbling within available temperature. Even if n is over 15 moles, the complex cleaning and degreasing agent does not affect cleaning proficiency without change with the lapse of time at high temperature, but has no industrial availability because of too much quantity of glycol ethers, enzyme, chealating agent and complex surfactant.

Seeing the results of surfactants having different mole ratio of m and n carefully, we can conclude that it is good to have a mole ratio of m/n of 0.5-1.27. When a cleaning and degreasing agent composition is made up of alkaline builder and a single surfactant without glycol ethers. enzyme, cleaning agent, if the mole ratio of m/n is less than 0.5, the composition has low bubbling property, but low cleaning proficiency, so it is not advisable. And if mole ratio is over 0.9, the composition has good cleaning proficiency, but has too much bubbling, so cleaning and degreasing agent is not good for availability.

In addition, when a complex cleaning and degreasing agent composition comprises glycol ethers, enzyme, chelating agent, alkaline builder and complex surfactant, if the mole ratio of m/n is less than 0.5, the composition has low bubbling property, but has low cleaning proficiency within available temperature, so it is not advisable. And if the mole ratio is over 1.27, the composition has good cleaning proficiency, but is not good for availability because of too much bubbling.

The contents of each surfactant composition are preferably 1 wt % or more of weight of surfactants, and more preferably 5 wt % or more.

### EXAMPLE

1) Example of Complex Cleaning and Degreasing Agent.

Composition of complex cleaning agent of present invention as described in the following Table 1

TABLE 1

| | Example | Example | Example | Example | Example | Example |
|---|---|---|---|---|---|---|
| | 1 | 2 | 3 | 4 | 5 | 6 |
| Sodium | 6.25 | 6.25 | 7.45 | 7.45 | 4.78 | 4.78 |
| ca5bonate | | | | | | |
| Caustic soda | 1.20 | | | | 1.20 | 1.20 |
| Caustic | 2.40 | 2.40 | 2.70 | 2.70 | 1.20 | 1.20 |
| potash | | | | | | |
| Sodium | | 4.05 | 4.05 | 4.05 | | 1.50 |
| metasilicate | | | | | | |
| Glycol | | | | | | |
| Glycol ether 1 | 7.68 | 8.68 | 9.68 | 9.68 | 3.08 | 3.08 |
| Glycol ether 2 | 15.36 | 17.36 | 19.36 | 19.36 | 6.15 | 6.15 |
| Glycol ether 3 | 7.68 | 5.68 | 7.68 | 7.68 | 3.08 | 3.08 |
| Enzyme | 1.70 | 1.70 | 1.70 | 1.70 | 1.70 | 1.70 |
| Chelating | 1.0 | 1.0 | 1.0 | 1.0 | 1.0 | 1.0 |
| agent | | | | | | |
| Surfactant | | | | | | |
| Complex | 10.0 | | | | | |
| surfactant1 | | | | | | |
| R; 9, m: 1.5, 1.5, | | | | | | |
| 1.3 | | | | | | |
| n: 3 | | | | | | |
| m/n: 0.5 | | | | | | |
| Complex | | 5.0 | | | | |
| surfactant2 | | | | | | |
| R; 8, m: 1.5, 3, 9 | | | | | | |
| n: 7 | | | | | | |
| m/n: 0.43 | | | | | | |
| Complex | | | 3.5 | 1.5 | | |
| surfactant3 | | | | | | |
| R: 9, m: 1.5, 10, | | | | | | |
| 8, 15 | | | | | | |
| n: 12.1 | | | | | | |
| m/n: 0.89 | | | | | | |
| Complex | | | | 2.0 | | |
| surfactant4 | | | | | | |
| R: 11, m: 1.5, 10.9, | | | | | | |
| 15 | | | | | | |
| n: 14.5 | | | | | | |
| m/n: 0.75 | | | | | | |
| Complex | | | | | 3.0 | |
| surfactant5 | | | | | | |
| R: 15, m: 1.5, 12.5, | | | | | | |
| 17 | | | | | | |
| n: 15 | | | | | | |
| m/n: 0.83 | | | | | | |
| Complex | | | | | | 3.0 |
| surfactant6 | | | | | | |
| R: 19, m: 1.5, 18, | | | | | | |
| 17 | | | | | | |
| n: 15 | | | | | | |
| m/n: 1.20 | | | | | | |

2) Manufacture of Plate

Plates used in the present invention are steel plates, zinc-coated steel plates, alloyed zinc-coated steel plates, tin-coated steel plates, zinc, nickel, titanium, aluminum and aluminum alloy. The plate is cut to the size of 1.5×8 cm, and the cut surface is rubbed. After the rubbed plate is deposited in 3% Naoh solution for one minute, the rubbed plate is derived of alkaline solution by pure water and washed by the first class ethyl alcohol. After the washed plate is dried in an oven at 120° C. for 60 minutes, the washed plate is cooled to room temperature, and vacuum-dried in a vacuum drier.

3) Sample Plate

After weighing, the plates are stored in a vacuum drier and are pulled according to the kind of plate. Synthetic oil such as rolling oil, rust preventing oil, etc and silicon oil are sprayed equally on the plates by roll coater (1-2 g/m²) and the plates are heated in a 120° C. oven for 60 minutes, so that the moisture in the oil is dried and the plates are cooled to room temperature and vacuum-dried in a vacuum drier.

After the vacuum-dried example plates are weighed, they are stored in a vacuum-drier again and used for the experiment.

4) Measurement of Fat-Removal Rate

To improve a fat-removal rate, after the prepared plates are deposited in each container in which the fat-removal solution is maintained at 25° C. and 95° C., the prepared plates are extracted and dipped for 30 seconds in a tank which is full of pure water of room temperature, and washed, and at this time the prepared plates are agitated slightly.

The plates are then heated in a 120° C. oven for 60 minutes, derived of moisture, cooled to room temperature, and vacuum-dried in a vacuum-drier.

After the fat-removal procedure, the quantity of remaining oil on the plate is measured by a surface carbon analyzer through an analysis of the quantity of organic carbon.

During the process of preparing the sample, weight differences per unit area before and after the coating of each plate can be calculated, and this value is the quantity of coated oil.

The result of non-fat-removed plate by surface carbon analysis does not concur with the result obtained by weight difference, but has some ratio. Therefore, some ratio is multiplied to quantity of coating, and the result is quantity of surface carbon before fat-removal.

The quantity of surface carbon after fat-removal is obtained by the way that quantity of surface carbon remained after fat-removal is detracted from quantity of coating before fat-removal.

The ratios in Table 2 are worked out as the ratio of the quantity of surface carbon before fat-removal and the quantity of surface carbon after fat-removal is acquired, and this ratio is multiplied by 100.

5) Experiment of Foaming

In the experiment of foaming, 50 ml of the complex cleaning and degreasing agent is poured in a mass cylinder of 200 ml with a stopper into each container which is maintained 250° C. and 950° C., and shaken 20 times. The scale of the mass cylinder measures the quantity of foaming, and the results are indicated in Table 2.

TABLE 2
Result of experiment of oil-removal and foaming

| | Example | Example | Example | Example | Example | Example |
|---|---|---|---|---|---|---|
| | 1 | 2 | 3 | 4 | 5 | 6 |
| Experiment of fat- | 100 | 100 | 100 | 100 | 100 | 100 |
| removing, %, 25° C. | | | | | | |
| Experiment of fat- | 100 | 100 | 100 | 100 | 100 | 100 |
| removing, %, 25° C. | | | | | | |
| Experiment of | 0-1 | 0-1 | 0-1 | 0-1 | 0-1 | 0-1 |
| foaming, %, 25° C. | | | | | | |
| Experiment of | 0-1 | 0-1 | 0-1 | 0-1 | 0-1 | 0-1 |
| foaming, %, 25° C. | | | | | | |

As mentioned above, (1) the cleaning agent of the present invention can remove various oil and grease used during manufacturing process of metal from the surface of metal such as steel, steel plate, zinc-coated steel plate, alloyed zinc-coated steel plate, tin-coated steel plate, zinc, nickel, titanium, aluminum and aluminum alloy, without impairing the raw materials.

Also, to fully satisfy the purpose of chemical treatment of metal surface or painting before chemical treatment, the cleaning agent of the present invention can remove any kind of pollutant on surface without impairing the raw materials, show good cleaning and degreasing proficiency, and maintain an anti-foaming property at room temperature during spraying cleansing and depositing cleansing without heating.

(2) The complex cleaning and degreasing agent of the present invention shows good cleaning and degreasing proficiency without impairing raw materials at room temperature to less than 100° C. during cleaning and degreasing oil on any kinds of painted metal surface. Therefore, the present invention is good for cleaning and degreasing small, medium and large vehicles including trains, the outside of airplanes, wheel hubs, rotary printing machines and any kind of machinery and instrument.

(3) As the complex cleaning and degreasing agent of the present invention does not impair any kind of metal and plastic material; silicon, carbon, fiberglass, graphite, ceramic, plastic, vinyl, carpet, rug, natural and synthesized rubber, it is good for cleaning and degreasing components of small, medium and large vehicles, trains and airplanes, rotary printing machines, printing machines and any kind of machinery and instrument.

(4) If the contents of glycol ethers, enzyme, chelating agent, alkaline builder and water are suitably regulated, the cleaning and degreasing agent of the present invention is best used as a multipurpose, multifunctional complex cleaning agent used at home, and a pre-washing agent used to deal with old grime on shirt sleeves and collars.

What is claimed is:

1. A complex cleaning and degreasing agent comprising an alkaline builder and a surfactant of the following formulae 1 to 4.
[Formula 1]
R—O—(CH₂CH₂O)m-H 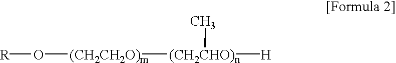
[Formula 3]
R-Ph-O—(CH₂CH₂O)-m-H
[Formula 4]
R-Ph-SO₃⁻M⁺
Wherein, R is C3-C19 alkyl group, Ph is the phenyl group, m is 1. 12 for formula 1 and formula 2, and 13-19 for formula 3, n is 2-15, and M is counter ion.

2. The complex cleaning and degreasing agent according to claim 1, wherein the mole ratio of m/n of the formula 3 is 0.5-1.27.

3. The complex cleaning and degreasing agent according to claim 1 further comprising glycol ethers, enzyme and chelating agent.

4. The complex cleansing and degreasing agent according to claim 1, wherein the contents of the complex surfactants are 0.1-10.0 g per 1 liter of cleaning agent.
